(19) United States
(12) Patent Application Publication
(10) Pub. No.: US 2006/0047973 A1
(43) Pub. Date: Mar. 2, 2006

(54) Method of preventing multimedia copy

(75) Inventor: Young Kuk Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 11/218,750

(22) Filed: Sep. 2, 2005

(30) Foreign Application Priority Data
Sep. 2, 2004 (KR) 10-2004-0069943

(51) Int. Cl. G06F 12/14; G06F 11/30

(52) U.S. Cl. 713/190

(57) ABSTRACT

A method of preventing a multimedia copy is disclosed, by which an illegal use such as a distribution, a copy and the like without permission can be prevented through fast transformation and security management of multimedia downloaded via a network (Internet, wireless Internet, etc.) and by which an illegal inter-user-equipment copy of multimedia downloaded via a network (Internet, wireless Internet, etc.) can be prevented. The present invention includes the steps of dividing prescribed multimedia requested from a user equipment by a block unit, generating an encryption code for the user equipment by performing an encryption operation on at least one unique code for an identification of the user equipment, encrypting a prescribed block of the multimedia with the generated encryption code, and downloading the encrypted block.

This application claims the benefit of the Korean Patent Application No. 10-2004-0069943, filed on Sep. 2, 2004, which is hereby incorporated by reference as if fully set forth herein.

### BACKGROUND OF THE INVENTION

1. Field of the Invention

The present invention relates to a method of preventing a multimedia copy. Although the present invention is suitable for a wide scope of applications, it is particularly suitable for preventing an illegal multimedia copy between terminals.

2. Discussion of the Related Art

Generally, various communication providers provide a variety of multimedia download services.

An operation of a conventional multimedia download service is explained as follows.

First of all, a user equipment accesses a prescribed wireless or wire Internet.

Subsequently, the user equipment accesses a server of a contents provider that provides multimedia or a server of a download service provider.

Once a user selects specific multimedia via the user equipment, the corresponding server informs the user of billing information according to a use of the multimedia.

If the user requests a download of the corresponding multimedia via the user equipment, the corresponding download is performed via the wireless Internet.

After completion of the download of the corresponding multimedia to the user equipment, the downloaded multimedia is stored in the user equipment. In doing so, the server generates billing-associated information for the user.

The user uses the multimedia stored in his user equipment (image output, sound output, etc.). In this case, the multimedia is the general term for sound data such as MMF, MIDI, MPS and the like and image data such as BMP, JPG and the like.

The multimedia stored intact in the user equipment. And, the user equipment plays back the stored data using a built-in decoder.

And, the multimedia stored in the user equipment can be deleted together with the associated information if the user wishes.

Meanwhile, since the contents provider has the copyright of the multimedia downloaded to the user equipment, the corresponding multimedia should not be distributed without permission.

Yet, it is impossible for the contents provider to manage his copyright protection for the downloaded multimedia.

Namely, as the user equipment becomes equipped with a huge storage space, the multimedia having been downloaded to the user equipment can be distributed without permission in the following methods.

In spite of the distribution without permission, the contents provider is unable to technically cope with the unilateral multimedia distribution without permission or other illegal uses of the multimedia.

1. Distribution without permission via Internet after downloading multimedia to a personal computer using a serial USB cable

2. Copy without permission to a user equipment from a personal computer after downloading multimedia to the personal computer using a serial USB cable

3. Multimedia transmission to another user equipment without permission using an image/sound transmission function provided to a user equipment after downloading the multimedia

Hence, many efforts have been made to research and study the multimedia security method by service providers according to the rising demand for security relating technology compensatory for the download service of the multimedia.

However, a concrete compensatory method for the multimedia downloaded via network (Internet or wireless Internet) has not been provided yet.

### SUMMARY OF THE INVENTION

Accordingly, the present invention is directed to a method of preventing a multimedia copy that substantially obviates one or more problems due to limitations and disadvantages of the related art.

An object of the present invention is to provide a method of preventing a multimedia copy, by which an illegal use such as a distribution, a copy and the like without permission can be prevented through fast transformation and security management of multimedia downloaded via a network (Internet, wireless Internet, etc.).

Another object of the present invention is to provide a method of preventing a multimedia copy, by which an illegal inter-user-equipment copy of multimedia downloaded via a network (Internet, wireless Internet, etc.) can be prevented.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of preventing a multimedia copy according to the present invention includes the steps of dividing prescribed multimedia requested from a user equipment by a block unit, generating an encryption code for the user equipment by performing an encryption operation on at least one unique code for an identification of the user equipment, encrypting a prescribed block of the multimedia with the generated encryption code, and downloading the encrypted block.

Preferably, the encryption code is a result from encrypting the unique code using a hash function. More preferably, the unique code comprises an electronic serial number (ESN) of the user equipment. More preferably, the unique code includes a mobile identification number (MIN) of the user equipment. More preferably, the unique code includes an Internet protocol address of the user equipment.

Preferably, the encrypting step is carried out in a manner of performing an exclusive OR operation on the generated encryption code and the prescribed block of the multimedia.

Preferably, the method further includes the step of downloading rights objects including a file name of the multimedia and a validity period of the multimedia. Preferably, the method further includes the step of downloading a validity period wherein the validity period is previously set by a copyright proprietor of the multimedia.

In another aspect of the present invention, a method of preventing a multimedia copy in a user equipment includes the steps of receiving prescribed multimedia by a block unit, generating an encryption file to verify whether to use the received multimedia, and storing the multimedia of the block unit and the generated encryption file.

Preferably, the encryption file is a result from encrypting rights objects of the multimedia using a hash function. More preferably, the rights objects of the multimedia includes a file name of the multimedia and a validity period of the multimedia.

Preferably, the encryption file is a result of encrypting a specific block of the multimedia using a hash function.

Preferably, the multimedia of the block unit and the generated encryption file are stored in a file system.

Preferably, the method further includes the step of performing a verification of whether to use the stored multimedia using the stored encryption file if a reproduction of the stored multimedia is attempted. More preferably, the verification performing step includes the steps of generating a new encryption file using at least one of rights objects of the multimedia and a specific block of the multimedia and deciding a presence or non-presence of a coincidence by comparing the generated new encryption file to the stored encryption file.

More preferably, if the two encryption files are identical to each other, the stored multimedia is reproduced. More preferably, if the two encryption files are not identical to each other, the stored multimedia and the stored encryption file are deleted. More preferably, if the two encryption files are identical to each other, the verification is further performed using the validity period of the multimedia.

Preferably, the method further includes the step of verifying whether to use the stored multimedia using the stored encryption file in case of booting the user equipment. More preferably, the verifying step includes the steps of generating a new encryption file using at least one of rights objects of the multimedia and a specific block of the multimedia and deciding a presence or non-presence of a coincidence by comparing the generated new encryption file to the stored encryption file, wherein the rights objects includes a file name and a validity period of the multimedia.

More preferably, if the two encryption files are identical to each other, a booting of the user equipment is normally completed. More preferably, if the two encryption files are not identical to each other, the stored multimedia and the stored encryption file are deleted. More preferably, if the two encryption files are identical to each other, the verification is further performed using the validity period of the multimedia.

Preferably, the method further includes the step of receiving a validity period of the multimedia wherein the validity period is previously set by a copyright proprietor of the multimedia.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart of a process of downloading and storing multimedia according to the present invention;

FIG. 2 is a flowchart of a process of generating a security file according to the present invention;

FIG. 3 is a flowchart of a process of reproducing multimedia according to a first embodiment of the present invention;

FIG. 4 is a flowchart of a process of reproducing multimedia according to a second embodiment of the present invention;

FIG. 5 is a flowchart of a process of verifying a legal use of multimedia and a process of deleting the corresponding multimedia according to a first embodiment of the present invention; and

FIG. 6 is a flowchart of a process of verifying a legal use of multimedia and a process of deleting the corresponding multimedia according to a second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, the present invention carries out the following procedures.

Firstly, multimedia is downloaded by block unit and each block data is transformed according to a predetermined pattern while the downloaded multimedia is stored in a user equipment.

Secondly, an encryption file for controlling the multimedia downloaded/stored in each user equipment is generated.

Thirdly, in reproducing the multimedia downloaded/stored to/in the user equipment, a legal use of the multimedia is verified. And, in booting the user equipment, a legal use of the downloaded/stored multimedia is verified. In particular, illegal multimedia according to the verification is deleted. And, in reproducing the downloaded/stored multimedia or in booting the user equipment, a control of the corresponding multimedia is carried out by a proprietor.

Meanwhile, the user equipment explained in the foregoing description or a user equipment to be explained later in the following description may include a personal computer enabling a general Internet access, a mobile terminal accessible to wireless Internet, or the like.

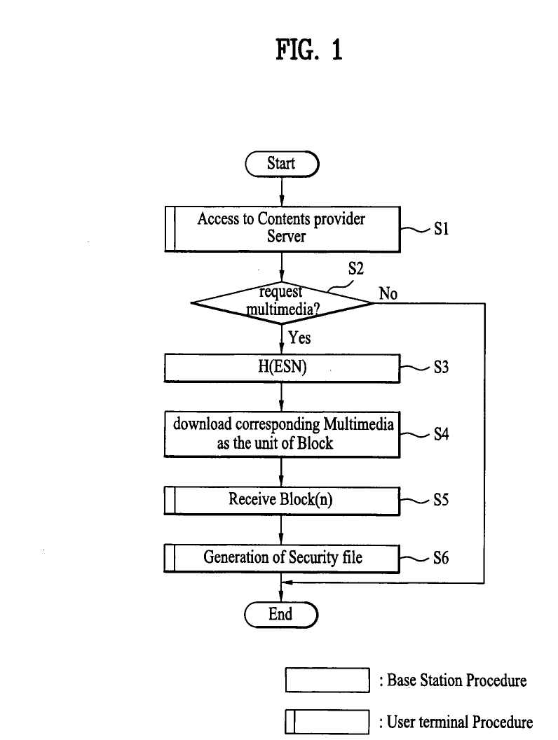

A procedure of downloading/storing multimedia is explained in detail with reference to FIG. 1 as follows.

FIG. 1 is a flowchart of a process of downloading and storing multimedia according to the present invention.

Referring to FIG. 1, a server operation is explained in the following.

First of all, if prescribed multimedia is requested from a user equipment, a server divides the requests multimedia into blocks by a block unit having a predetermined size. And, the server generates an encryption code for encrypting the divided blocks. In this case, the encryption code is generated in a manner that an encryption operation is performed on unique code(s) of the user equipment to identify the user equipment that has requested the multimedia.

Subsequently, the server encrypts each of the blocks with the generated encryption code before downloading the divided blocks. The server then downloads the encrypted blocks to the user equipment. While the server downloads the multimedia by the block unit, the server downloads rights objects of the multimedia including a file name, a validity period, etc of the multimedia.

An operation of the user equipment is carried out as follows.

First of all, the user equipment stores the multimedia, which was downloaded from the server, by block unit.

After completion of a download of the multimedia by receiving a last block, the user equipment automatically generates a security file (encryption file) to be used for verification of the stored multimedia in reproduction or initial drive (booting). In doing so, the user equipment uses a specific block of the multimedia or rights objects of the multimedia (wherein the rights objects includes file name, valid period, etc.) in generating the security file (encryption file).

And, the user equipment stores the generated security file (encryption file) in a storage means. In this case, the storage means includes a file system for managing the stored multimedia blocks.

Subsequently, if a reproduction of the stored multimedia is requested by a user or if the user equipment is initially driven (booted), the user equipment decides a presence or non-presence of coincidence with the security file (encryption file) and then confirms the valid period of the stored multimedia additionally. Through theses procedures, the stored multimedia is verified.

Hence, the user equipment failing in downloading the multimedia from the server properly is unable to acquire the entire data necessary for the verification. So, the user equipment failing in downloading the multimedia from the server properly cannot reproduce the multimedia even if the multimedia is obtained from another user equipment.

The present invention is explained in detail with reference to FIG. 1 as follows.

Referring to FIG. 1, a user equipment accesses prescribed Internet or prescribed wireless Internet.

Subsequently, the user equipment accesses a server (hereinafter called a contents server) of a contents provider that provides various contents (S1). Alternatively, the user equipment accesses a server of a download service provider. In the following, a case of downloading multimedia as contents from the contents server is exemplarily explained.

First of all, the contents server provides information relating to various multimedia to the user equipment having accessed the contents server.

If a user selects prescribed multimedia using a user interface (e.g., display and keys, etc.) provided to the user equipment, the contents server provides billing information (a fee for using the corresponding multimedia) for the selected multimedia to the user equipment. Hence, the user is able to confirm the corresponding billing information via the user interface.

Subsequently, if the user requests a download of at least one multimedia again using the user interface provided to the user equipment (S2), the contents server divides the corresponding multimedia into blocks by a block unit and then downloads the divided blocks to the user equipment (S4). While the server downloads the multimedia by the block unit, the server further downloads rights objects of the multimedia including a file name, a validity period, etc of the multimedia.

In the present invention, prior to the download of the multimedia, the contents server generates a unique encryption code to be allocated to the accessing user equipment (S3). And, the contents server carries out an exclusive OR operation on the generated encryption code with block data of the multimedia to be downloaded.
Block(k) u H(ESN) [Formula 1]

In Formula 1, ‘k (=1, 2, 3, . . . , i, . . . , n−1, n)’ is a variable to indicate a corresponding number of block data in dividing the multimedia to be downloaded by the block unit. ‘ESN’ is an electronic serial number uniquely given to the user equipment. And, ‘H(SEN)’ is a hash function value for the ESN and corresponds to the encryption code.

The encryption code is a result from performing an encryption operation on the code (number or identifier), which is uniquely given to the user equipment or to identify a user, using a prescribed encryption function such as a hash function and the like. In this case, the number of identifier used for the encryption operation includes the ESN, an MIN (mobile identification number) uniquely given to the user equipment, an Internet protocol address or the like.

Hence, the contents server downloads a result (Formula 1) from performing the exclusive OR operation (XOR) on the encryption code with the block data configuring the multimedia to the user equipment.

Correspondingly, the user equipment receives the multimedia by the block unit. Once a last block Block(n) corresponding to the multimedia is received, the user equipment stores the entire received blocks in a storage means (e.g., system file). Substantially, the user equipment receives a plurality of results (blocks) of the exclusive OR operation between the encryption code and each of the block data configuring the multimedia. Hence ‘Block(1) substantially indicates ‘Block(1) u H(ESN)’ and the last block Block(n) indicates ‘Block(n) u H(ESN)’.

After completion of receiving the last block ‘Block(n) p Block(n) u H(ESN)’ (S5), the user equipment generates a security file (encryption file (S6).

Meanwhile, a procedure or process of generating the security file (encryption file) for the user equipment to control the downloaded multimedia is explained in the following.

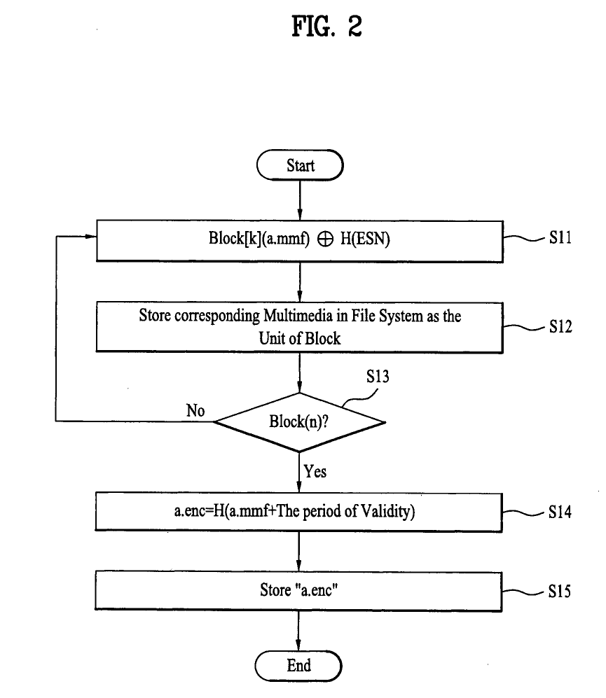

FIG. 2 is a flowchart of a process of generating a security file according to the present invention.

Referring to FIG. 2, it is assumed that a file name of multimedia downloaded to a user equipment is ‘a.mmf’.

The user equipment stores the multimedia downloaded by the procedure shown in FIG. 1 in a storage means by a block unit (S11-S13). Hence, the multimedia stored in the storage means follows Formula 2.
Block(k)[a.mm] u H(ESN) [Formula 2]

In Formula 2, ‘k (=1, 2, 3, . . . , i, . . . , n−1, n)’ is a variable to indicate a corresponding number of block data in dividing the downloaded multimedia by the block unit and ‘[a.mmf]’ is a file name of the multimedia.

Once a last block Block(n) ‘Block(n)[a.mmf] u H(ESN)’ is stored in the storage means, the user equipment generates a security file (encryption file) that follows Formula 3 (S14).
security file[a.enc]=H(a.mmf+the period of validity) [Formula 3]

In Formula 3, the validity period is used for a copyright proprietor to control the multimedia downloaded to the user equipment.

Meanwhile, the security file can be generated in various forms including the case of Formula 3.

For another instance, the security file is generated by combining a specific block of the multimedia itself with the validity period. Namely, the security file (encryption file) following Formula 4 is generated.
security file[a.enc]=H(Block(k)+the period of validity) [Formula 4]

In Formula 4, ‘Block(k)’ is pure block data configuring the multimedia or a result of performing an exclusive OR operation on the pure block data with the encryption code.

The user equipment stores the above-generated security file ‘a.enc’ in the storage means (S15).

For another instance, a security file is generated in a manner of performing an encryption operation on a multimedia file name only with the hash function. Namely, a security file (encryption file) in Formula 5 is generated.
security file[a.enc]=H(a.mmf) [Formula 5]

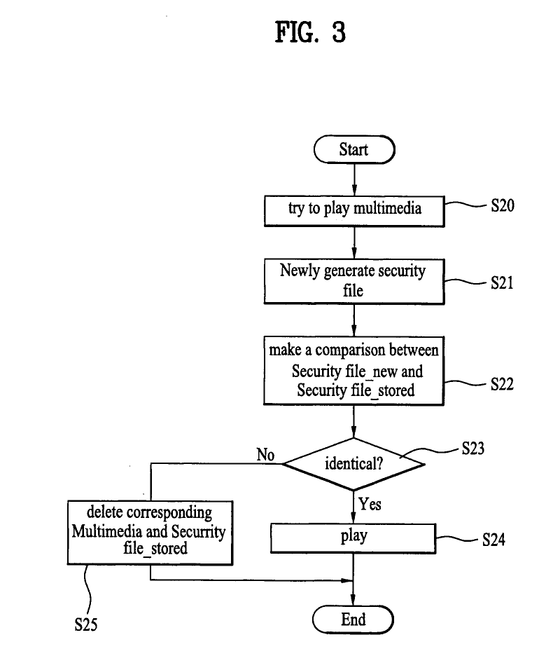

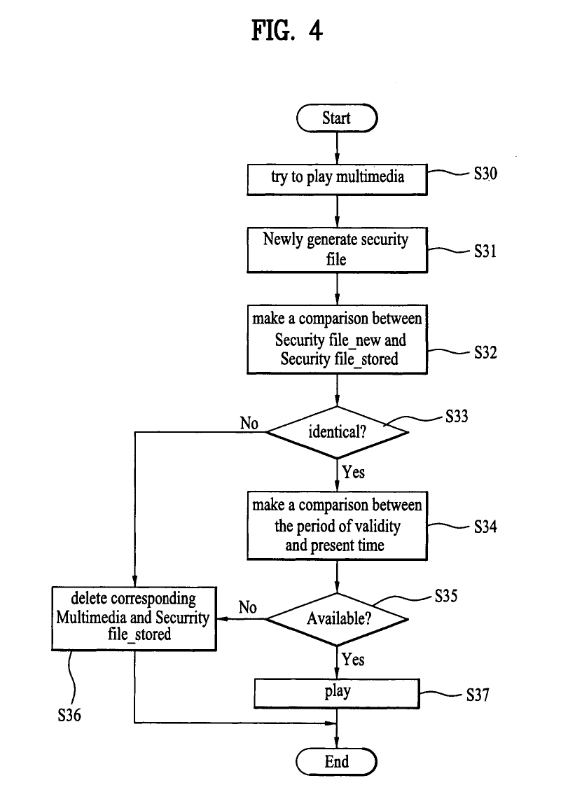

The security file if Formula 5 is more facilitated than the reproduction of the multimedia shown in FIG. 3 or FIG. 4.

Meanwhile, for the procedure shown in FIG. 2, in downloading the multimedia, the contents server downloads right objects including a validity period previously set by a copyright proprietor of the corresponding multimedia. If so, the user equipment links the validity period to the corresponding multimedia to store in the storage means.

And, the generation of the security file in FIG. 2 is automatically executed during the multimedia download or after completion of the multimedia download.

FIG. 3 is a flowchart of a process of reproducing multimedia according to a first embodiment of the present invention.

Referring to FIG. 3, a user equipment performs a verification on multimedia stored in a storage means. And, the user equipment reproduces (plays back) or deletes the multimedia according to a result of the verification. In this case, it is assumed that the verification is performed using the security file of Formula 5.

If a user attempts to reproduce prescribed multimedia stored in the storage means (e.g., file system) using a user interface provided to the user equipment (S20), the user equipment performs a hash function encryption operation to generate a security file (encryption file) using a file name ‘a.mmf’ of rights objects of the corresponding multimedia. Namely, the user equipment performs the encryption operation of Formula 5.

Hence, a new security file (Security file_new) is generated (S21).

Subsequently, the user equipment compares the newly generated security file (Security file_new) to a previously stored security file (Security file_stored) by linking the newly generated security file to the multimedia the user attempts to reproduce (S22). In this case, the previously stored security file (Security file_stored) is the one stored in the storage means after completion of the encryption operation using a multimedia file name in downloading the corresponding multimedia.

If the two compared security files are identical to each other, the corresponding stored multimedia is reproduced (S23, S24).

On the other hand, if the two compared security files are not identical to each other, the corresponding stored multimedia and its security file (encryption file) are deleted (S25).

FIG. 4 is a flowchart of a process of reproducing multimedia according to a second embodiment of the present invention.

Referring to FIG. 4, a user equipment performs a verification on multimedia stored in a storage means. And, the user equipment reproduces (plays back) or deletes the multimedia according to a result of the verification. In this case, it is assumed that the verification is performed using the security file of Formula 5. And, a validity period of rights objects of the multimedia is further used for the verification.

If a user attempts to reproduce prescribed multimedia stored in the storage means (e.g., file system) using a user interface provided to the user equipment (S30), the user equipment performs a hash function encryption operation to generate a security file (encryption file) using a file name ‘a.mmf’ of rights objects of the corresponding multimedia. Namely, the user equipment performs the encryption operation of Formula 5.

Hence, a new security file (Security file_new) is generated (S31).

Subsequently, the user equipment compares the newly generated security file (Security file_new) to a previously stored security file (Security file_stored) by linking the newly generated security file to the multimedia the user attempts to reproduce (S32). In this case, the previously stored security file (Security file_stored) is the one stored in the storage means after completion of the encryption operation using a multimedia file name in downloading the corresponding multimedia.

If the two compared security files are identical to each other, the validity period of the corresponding multimedia is further compared to a current date (time) (S33, S34).

Meanwhile, if the stored validity period stored does not exceed the current date (time) to make the period valid as a result of the comparison, it is decided that the corresponding multimedia is valid. And, the user equipment reproduces the corresponding multimedia successful in the verification (S35, S37).

On the other hand, if the two compared security files are not identical to each other, the user equipment deletes the corresponding stored multimedia and its security file (encryption file) (S36).

Moreover, if the stored validity period stored exceeds the current date (time) according to the result of the comparison between the validity period of the multimedia and the current date (time), the user equipment deletes the corresponding stored multimedia and its security file (encryption file) as well (S36).

As mentioned in the foregoing description, in FIG. 4 of the present invention, the validity period set by a copyright proprietor is compared to the current date (time) in the user equipment prior to reproducing the multimedia. And, if the validity period is expiry according to the comparison result, the corresponding stored multimedia is deleted. Preferably, the user equipment previously informs a copyright expiration via the user interface (e.g., display and speaker, etc.) prior to the deletion of the multimedia.

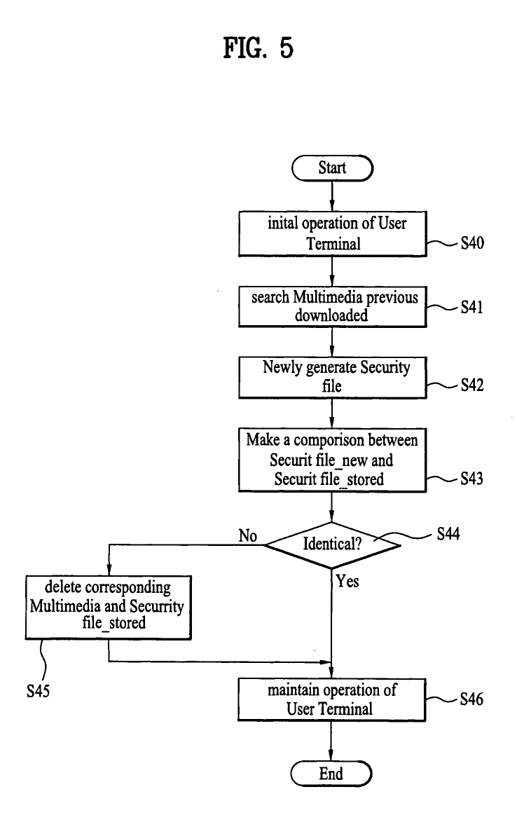

FIG. 5 is a flowchart of a process of verifying a legal use of multimedia and a process of deleting the corresponding multimedia according to a first embodiment of the present invention, in which a procedure executed in booting a user equipment is shown.

Referring to FIG. 5, a user equipment searches multimedia stored in a storage means (S41) in case of being driven or booted (S40).

If at least one multimedia is searched, an encryption operation is executed using the searched multimedia and rights objects (the rights objects includes file name, validity period, etc.) associated with the searched multimedia. Namely, a new security file (encryption file) is generated in a manner of performing an encryption operation on at least one of a prescribed block of the searched multimedia and the validity period of the searched multimedia with a hash function (S42).

Subsequently, the user equipment compares the newly generated security file (Security file_new) to a previously stored security file (Security file_stored) by linking the newly generated security file to the multimedia the user attempts to reproduce (S43). In this case, the previously stored security file (Security file_stored) is the one stored in the storage means after completion of the encryption operation using a multimedia file name in downloading the corresponding multimedia.

If the two compared security files are identical to each other, the user equipment maintains to be normally driven (S44, S46). Namely, a booting of the user equipment is normally completed.

On the other hand, if the two compared security files are not identical to each other, the user equipment deletes the corresponding stored multimedia and the security file (encryption file) of the multimedia and then maintains to be normally driven (S44, S45). Namely, a booting of the user equipment is normally completed after the multimedia and the security file (encryption file) of the multimedia have been deleted.

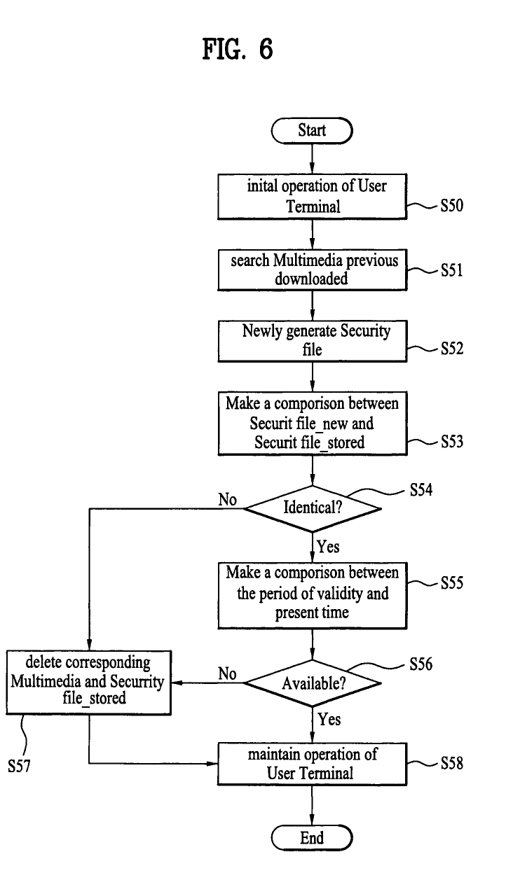

FIG. 6 is a flowchart of a process of verifying a legal use of multimedia and a process of deleting the corresponding multimedia according to a second embodiment of the present invention, in which a procedure executed in booting a user equipment is shown.

Referring to FIG. 6, a user equipment searches multimedia stored in a storage means (S51) in case of being driven or booted (S50).

If at least one multimedia is searched, an encryption operation is executed using the searched multimedia and information (e.g., file name, validity period, etc.) associated with the searched multimedia. Namely, a new security file (encryption file) is generated in a manner of performing an encryption operation on at least one of a prescribed block of the searched multimedia and the validity period of the searched multimedia with a hash function (S52).

Subsequently, the user equipment compares the newly generated security file (Security file_new) to a previously stored security file (Security file_stored) by linking the newly generated security file to the multimedia the user attempts to reproduce (S53). In this case, the previously stored security file (Security file_stored) is the one stored in the storage means after completion of the encryption operation using a multimedia file name in downloading the corresponding multimedia.

If the two compared security files are identical to each other, the validity period of the corresponding multimedia is further compared to a current date (time) (S54, S55).

If the stored validity period stored does not exceed the current date (time) to make the period valid as a result of the comparison, it is decided that the corresponding multimedia is valid. And, the user equipment maintains to be normally operated (S56, S58). Namely, a booting of the user equipment is normally completed.

On the other hand, if the two compared security files are not identical to each other, the user equipment deletes the corresponding stored multimedia and its security file (encryption file) (S57). Moreover, if the stored validity period stored exceeds the current date (time) according to the result of the comparison between the validity period of the multimedia and the current date (time), the user equipment deletes the corresponding stored multimedia and its security file (encryption file) as well (S57). Hence, the user equipment maintains to be normally driven after having deleted the corresponding stored multimedia and the security file (encryption file) of the corresponding stored multimedia (S58). Namely, the user equipment normally completes a booting of the user equipment after having deleted the multimedia and the security file (encryption file) of the multimedia.

In the above explanation, a fact that the user equipment is normally driven means that a reproduction of the stored multimedia is ready to be reproduced. It is a matter of course that the verification procedure shown in FIG. 3 or FIG. 4 is executed.

Meanwhile, the present invention is applicable to all kinds of client-to-server Internet services.

Accordingly, the present invention provides the following effects or advantages.

First of all, in a time point of downloading multimedia to a user equipment, the present invention enables a copyright of the downloaded multimedia to be set. Hence, the present invention can strengthen the protection of the copyright in the user equipment after completion of the download of the corresponding multimedia.

Secondly, the present invention provides a technical device of preventing such an illegal use as a case of distributing multimedia downloaded to a personal computer via Internet without permission, a case of copying multimedia downloaded to a personal computer into another user equipment without permission, a case of distributing multimedia, which is downloaded using an image/sound transmission function built in a user equipment, to another user equipment without permission and the like.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of preventing a multimedia copy, comprising the steps of:
dividing prescribed multimedia requested from a user equipment by a block unit;
generating an encryption code for the user equipment by performing an encryption operation on at least one unique code for an identification of the user equipment;
encrypting a prescribed block of the multimedia with the generated encryption code; and
downloading the encrypted block.

2. The method of claim 1, wherein the encryption code is a result from encrypting the unique code using a hash function.

3. The method of claim 2, wherein the unique code is an unique identifier of the user equipment.

4. The method of claim 2, wherein the unique code comprises at least one of an electric serial number (ESN), a mobile identification number (MIN) and an Internet protocol address of the user equipment.

5. The method of claim 1, wherein the encrypting step is carried out in a manner of performing an exclusive OR operation on the generated encryption code and the prescribed block of the multimedia.

6. The method of claim 1, further comprising the step of downloading rights objects including a file name and a validity period of the multimedia, wherein the validity period is previously set by a copyright proprietor of the multimedia.

7. The method of claim 1, further includes the step of downloading a validity period, wherein the validity period is previously set by a copyright proprietor of the multimedia.

8. A method of preventing a multimedia copy in a user equipment, comprising the steps of:
receiving prescribed multimedia by a block unit;
generating an encryption file to verify whether to use the received multimedia; and
storing the multimedia of the block unit and the generated encryption file.

9. The method of claim 8, wherein the encryption file is a result from encrypting rights objects of the multimedia using a hash function.

10. The method of claim 9, wherein the rights objects of the multimedia includes a file name of the multimedia and a validity period of the multimedia.

11. The method of claim 8, wherein the encryption file is a result of encrypting a specific block of the multimedia using a hash function.

12. The method of claim 8, wherein the multimedia of the block unit and the generated encryption file are stored in a file system.

13. The method of claim 8, further comprising the step of performing a verification of whether to use the stored multimedia using the stored encryption file if a reproduction of the stored multimedia is attempted.

14. The method of claim 13, the verification performing step comprising the steps of:
generating a new encryption file using at least one of rights objects of the multimedia and a specific block of the multimedia, wherein the rights objects includes a file name and a validity period of the multimedia; and
deciding a presence or non-presence of a coincidence by comparing the generated new encryption file to the stored encryption file.

15. The method of claim 14, wherein if the two encryption files are identical to each other, the stored multimedia is reproduced.

16. The method of claim 14, wherein if the two encryption files are not identical to each other, the stored multimedia and the stored encryption file are deleted.

17. The method of claim 14, wherein if the two encryption files are identical to each other, the verification is further performed using the validity period of the multimedia.

18. The method of claim 8, further comprising the step of verifying whether to use the stored multimedia using the stored encryption file in case of booting the user equipment.

19. The method of claim 18, the verifying step comprising the steps of:
generating a new encryption file using at least one of a file name, a validity period and a specific block of the multimedia, wherein the file name and the validity period are included in rights objects of the multimedia; and
deciding a presence or non-presence of a coincidence by comparing the generated new encryption file to the stored encryption file.

20. The method of claim 19, wherein if the two encryption files are identical to each other, a booting of the user equipment is normally completed.

21. The method of claim 19, wherein if the two encryption files are not identical to each other, the stored multimedia and the stored encryption file are deleted.

22. The method of claim 19, wherein if the two encryption files are identical to each other, the verification is further performed using the validity period of the multimedia.

23. The method of claim 8, further comprising the step of receiving a validity period of the multimedia wherein the validity period is previously set by a copyright proprietor of the multimedia.
